(19) United States
(12) Patent Application Publication
(10) Pub. No.: US 2014/0032202 A1
(43) Pub. Date: Jan. 30, 2014

(54) APPARATUS OF SYSTEM LEVEL SIMULATION AND EMULATION, AND ASSOCIATED METHOD

(71) Applicant: Cheng-Yen Huang, Hsinchu City (TW)

(72) Inventor: Cheng-Yen Huang, Hsinchu City (TW)

(21) Appl. No.: 13/664,427

(22) Filed: Oct. 31, 2012

(30) Foreign Application Priority Data
Jul. 30, 2012 (TW) 101127472

(51) Int. Cl. G06G 7/62

(52) U.S. Cl. 703/14

(57) ABSTRACT

An apparatus of system level simulation and emulation and an associated method are provided, where the apparatus includes: a simulation/emulation engine, an existing intellectual property (IP) installation platform, a speed driver, and an IP proxy. The simulation/emulation engine is utilized for performing at least one of simulation and emulation to make the apparatus be equipped with a first portion of a plurality of IP modules. The existing IP installation platform is utilized for installing a chip equipped with existing IP modules to make the apparatus be equipped with a second portion of the plurality of IP modules, where the second portion of the plurality of IP modules includes a specific IP module of the existing IP modules. With the aid of the speed driver, the apparatus utilizes the specific existing IP module without introducing any unnecessary delay.

### BACKGROUND OF THE INVENTION

1. Field of the Invention

The present invention relates to simulation and emulation in the chip design process, and more particularly, to an apparatus of system level simulation and emulation and the associated method.

2. Description of the Prior Art

Due to the continuous development of the semiconductor technology in recent years, various chips are broadly applied in many applications. In the process of developing these chips, the chip designer usually needs to simulate the behaviors of these chips so as to improve the chip design or demonstrate the design result to the electronic device manufacturers who are considering to use these chips in their products.

According to the related art, in some cases, performing the chip simulation with field-programmable gate array (FPGA) is a feasible method. Specifically, the FPGA can be regarded as a reprogrammable chip, where the user can design these FPGAs for different design requirements to thereby build customized hardware functions. Therefore, in the traditional chip simulation architecture, FPGA has become the preferred option of certain electronic device manufacturers due to the fact that using FPGA can decrease the cost. However, using FPGA may generate some problems for chip designers. For example, FPGA's insufficient speed can result in a distorted simulation result. Besides, FPGA's insufficient speed can obstruct the demonstration of the chip design result.

Please note that, the frequency that some FPGAs can support now is about 200 megahertz (MHz), and it seems that this frequency value is not high enough to support the target operation frequency of the latest chip design. With regard to some applications, the target operation frequency of the chip can reach 500 MHz, while in other applications, the target operation frequency of the chip can reach 1 GHz. The traditional chip simulation architecture can not satisfy the requirement of high-level chip designs. Therefore, a novel method to improve the chip simulation performance is required.

### SUMMARY OF THE INVENTION

Therefore, one objective of the present invention is to provide an apparatus of system level simulation and emulation and the associated method, to solve the problems mentioned above.

Another objective of the present invention is to provide an apparatus of system level simulation and emulation and the associated method, to satisfy the requirements of high-level chip designs.

The preferred embodiment of the present invention provides an apparatus of system level simulation and emulation. The apparatus includes: a simulation/emulation engine, an existing IP installation platform, a speed driver, and an IP proxy. The simulation/emulation engine is utilized for performing at least one of simulation and emulation to make the apparatus equipped with a first portion of a plurality of IP modules, where each IP module provides a function to the apparatus. The existing IP installation platform is utilized for installing a chip equipped with the existing IP module to make the apparatus equipped with a second portion of the plurality of IP modules, where the second portion of the plurality of IP modules includes a specific IP module in the existing IP modules, and the specific IP module provides a specific function to the apparatus. Besides, the speed driver is utilized for bridging the simulation/emulation engine to an interconnection between the simulation/emulation engine and the existing IP installation platform, and providing a cache service corresponding to the specific IP module to the simulation/emulation engine. Besides, the IP proxy is utilized for bridging the existing IP installation platform to the interconnection, and interacting with the speed driver to support the cache service corresponding to the specific IP module.

While the present invention provides the apparatus of system level simulation and emulation mentioned above, a method of system level simulation and emulation is provided correspondingly. The method includes: utilizing a simulation/emulation engine for performing at least one of simulation and emulation to make the apparatus equipped with a first portion of a plurality of IP modules, where each IP module provides a function to the apparatus; utilizing an existing IP installation platform and a chip installed thereon and equipped with the existing IP module for performing the operation, to make the apparatus equipped with a second portion of the plurality of IP modules, where the second portion of the plurality of IP modules includes a specific IP module in the existing IP modules, and the specific IP module provides a specific function to the apparatus; utilizing a speed driver for bridging the simulation/emulation engine to an interconnection between the simulation/emulation engine and the existing IP installation platform, and providing a cache service corresponding to the specific IP module to the simulation/emulation engine; and utilizing an IP proxy for bridging the existing IP installation platform to the interconnection, and interacting with the speed driver to support the cache service corresponding to the specific IP module.

An advantage of the present invention is that the apparatus and method of the present invention can simulate the chip behavior under design correctly to implement the emulation, and avoid the associated technical issue (for example, the distorted simulation result caused by the FPGA's insufficient speed; or the failed demonstration of the chip design result caused by the FPGA's insufficient speed). Besides, the apparatus and the method of the present invention can employ various IP modules required by user to perform system level simulation and emulation, especially using the existing, verified IP modules (for example, one or more released chip products available in the market; or chip products of different types in a series of chip products) to perform the system level simulation and emulation for achieving the best demonstration of the chip design result. The apparatus and method of the present invention can satisfy the requirement without generating undesired side effects for some applications like the chip with a target operation frequency reaching 500 MHz or 1 GHz.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus of system level simulation and emulation according to a first embodiment of the present invention.

FIG. 2 is a flowchart illustrating a method of system level simulation and emulation according to an embodiment of the present invention.

FIG. 3 is a diagram illustrating the access operation classification associated with the method shown in FIG. 2 in an embodiment.

FIG. 4 is a diagram illustrating the implementation detail associated with the apparatus shown in FIG. 1 in an embodiment, where the apparatus of the present invention can be applied in the embodiment shown in FIG. 3.

FIG. 5 is a diagram illustrating the access scheme associated with the method shown in FIG. 2 in an embodiment, where the access scheme of the embodiment applies the access operation classification shown in FIG. 3.

FIG. 6-FIG. 8 are diagrams illustrating the implementation detail associated with the access scheme shown in FIG. 5.

FIG. 9 is a diagram illustrating the implementation detail associated with the apparatus shown in FIG. 4 in an embodiment, where the architecture shown in FIG. 9 can be applied in the embodiment shown in FIG. 5.

FIG. 10 is a diagram illustrating the mapping of the IP modules associated with the method shown in FIG. 2 in an embodiment.

### DETAILED DESCRIPTION

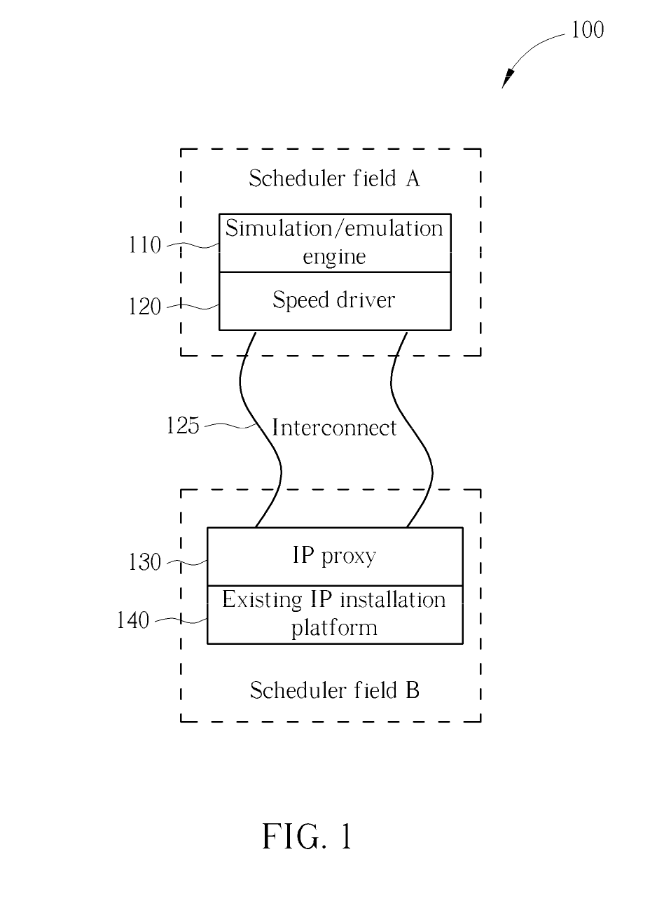

FIG. 1 is a diagram illustrating an apparatus 100 of system level simulation and emulation according to a first embodiment of the present invention. The apparatus 100 includes a simulation/emulation engine 110, a speed driver 120, an intellectual property (IP) proxy 130, and an existing IP installation platform 140. The simulation/emulation engine 110 is utilized for performing at least one of simulation and emulation (for one example, simulation and emulation; for another example, simulation or emulation) to make the apparatus 100 equipped with a first portion (e.g., a first subset {IP_{A}} of the IP modules {IP}) of a plurality of IP modules {IP}, where each IP module provides a function to the apparatus 100. The existing IP installation platform 140 is utilized for installing a chip equipped with IP modules {IP_{E}} to make the apparatus 100 equipped with a second portion (e.g., a second subset {IP_{B}} of the IP modules {IP}) of the plurality of IP modules {IP}, where the second portion (e.g., the second subset {IP_{B}} of the IP modules {IP}) includes a specific IP module IP_{S} in the existing IP modules {IP_{E}} (e.g., any existing IP module IP_{E} in the existing IP modules {IP_{E}}), and the specific IP module IP_{S} provides a specific function to the apparatus 100.

Besides, the speed driver 120 is utilized for bridging the simulation/emulation engine 110 to an interconnect 125 between the simulation/emulation engine 110 and the existing IP installation platform 140, and providing a cache service for the specific IP module IP_{S} to the simulation/emulation engine 110, where the speed driver 120 can provide system speed boost function to the apparatus 100 while performing the bridging, especially system speed boost function to the apparatus 100 for the specific IP module IP_{S} (according to the viewpoint of the programmer). Additionally, the IP proxy 130 is utilized for bridging the existing IP installation platform 140 to the interconnect 125, and interacting with the speed driver 120 to support the cache service for the specific IP module IP_{S}, where the IP proxy 130 can support the system speed boost function mentioned above when performing the bridging. Please note that, the speed driver 120 and the IP proxy 130 can be called “Native Speed Driver for Applied Engine” and “Native Intellectual Property Proxy for Applied Platform”, respectively. This is because that the speed driver 120 and the IP proxy 130 employ the innovative access scheme (the detail thereof will be described in some embodiments in the following).

The two sides of the interconnect 125 may belong to different scheduler domains, respectively. For example, the simulation/emulation engine 110 and the speed driver 120 may be located in a scheduler domain A, and the existing IP installation platform 140 and the IP proxy 130 may be located in a scheduler domain B.

In practice, the examples of the simulation/emulation engine 110 include (but not limited): Verilog simulator equipped with system bench like the so-called NC-Verilog (Verilog is a language used to describe the hardware and original name “Verilog” is commonly used in industry); system emulator like QEMU (QEMU is software of simulating the processor, and the original name “QEMU” is commonly used in industry), Simics (Simics is a full-system simulator, and the original name “Simics” is commonly used in industry), OVPsim (OVPsim is a multiprocessor platform simulator, and the original name “OVPsim” is commonly used in industry), etc.

Besides, examples utilized for implementing the technology of the existing IP installation platform 140 may include (but not limited): a register transfer language level (RTL) IP module; an IP module design implemented via FPGA or implemented in FPGA; an IP module design implemented via application-specific integrated circuit (ASIC) or implemented in ASIC, etc. Hence, the IP module on the existing IP installation platform 140 may include the software IP module, the hardware IP module and/or the FPGA IP module.

Additionally, in the case that the interconnect 125 is a logical connection, the examples of the technology utilized for implementing the interconnect 125 may include (but not limited): an inter-process communication (IPC), a transport layer interface (TLI), etc. In the case that the interconnect 125 is a physical connection, examples of the technology utilized for implementing the interconnect 125 may include (but not limited): a memory, a bus, an interface (e.g., peripheral component interconnect (PCI), PCI express (PCIe), universal serial bus (USB), serial advanced technology attachment (SATA), Ethernet, serializer/deserializer (SerDes)), etc.

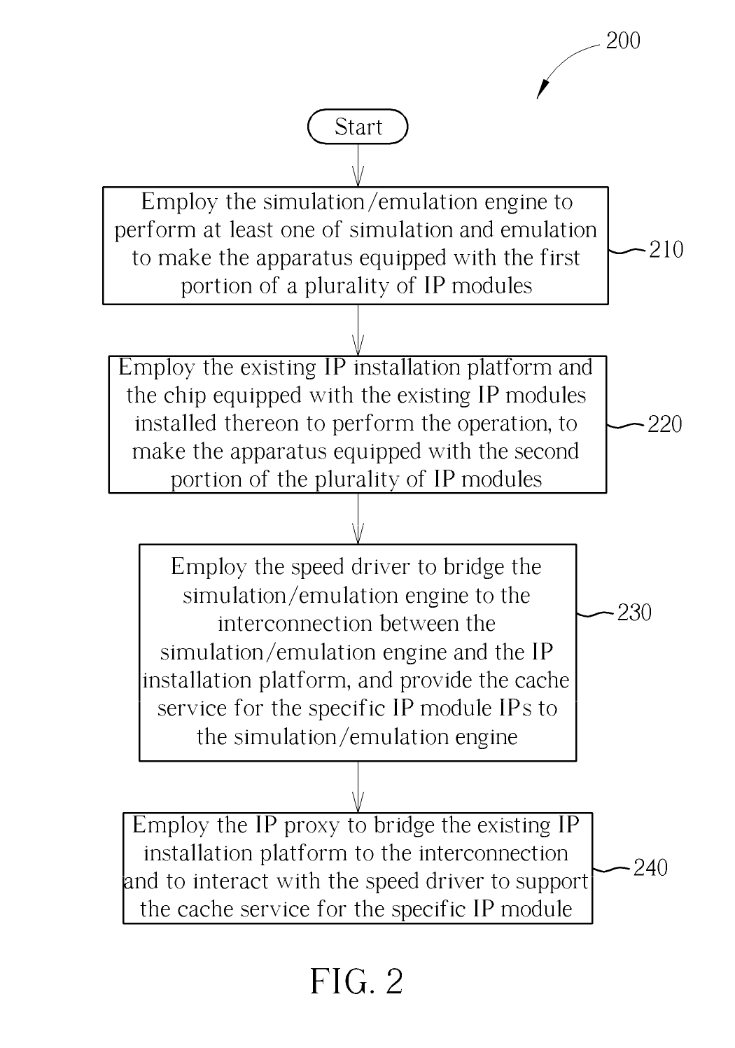

FIG. 2 is a flowchart illustrating a method 200 of system level simulation and emulation according to an embodiment of the present invention. The method 200 can be applied to the apparatus 100 mentioned above. The method is described as below.

In step 210, the apparatus 100 employs the simulation/emulation engine 110 to perform at least one of simulation and emulation (for one example, simulation and emulation; for another example, simulation or emulation) to make the apparatus 100 equipped with the first portion of a plurality of IP modules {IP} (e.g., the first subset {IP_{A}} of the IP modules {IP}), where each IP module IP provides a function to the apparatus 100.

In step 220, the apparatus 100 employs the existing IP installation platform 140 and the chip equipped with the existing IP modules {IP_{E}} installed thereon to perform the operation, to make the apparatus 100 equipped with the second portion of the plurality of IP modules {IP} (e.g., the second subset {IP_{B}} of the IP modules {IP}), where the second portion of the plurality of IP modules {IP} (e.g., the second subset {IP_{B}} of the IP modules {IP}) includes the specific IP module IP_{S} in the existing IP modules {IP_{E}} (e.g., any existing IP module IP_{E} in the existing IP modules {IP_{E}}), and the specific IP module IP_{S} provides a specific function to the apparatus 100.

In step 230, the apparatus 100 employs the speed driver 120 to bridge the simulation/emulation engine 110 to the interconnection 125 between the simulation/emulation engine 110 and the IP installation platform 140, and provide the cache service for the specific IP module IP_{S} to the simulation/emulation engine 110.

In step 240, the apparatus 100 employs the IP proxy 130 to bridge the existing IP installation platform 140 to the interconnection 125 and to interact with the speed driver 120 to support the cache service for the specific IP module IP_{S}.

Please note that the flowchart illustrated in FIG. 2 is only for the description purpose, and is not meant to be a limitation to the present invention. The execution order of at least one portion (e.g., part or all) of the steps shown in FIG. 2 can be changed according to some variations of this embodiment. At least one portion (e.g., part or all) of the steps shown in FIG. 2 can be performed at the same time according to some variations of this embodiment. At least one portion (e.g., part or all) of the steps shown in FIG. 2 can be performed repeatedly according to some variations of this embodiment.

According to the embodiment shown in FIG. 2, the existing IP installation platform 140 may include at least one specific register PV_Reg. The apparatus 100 follows at least one portion of the plurality of access rules {R}, such as the access rules R5 and R6 for the specific register PV_Reg, to perform the cache service, where the specific register PV_Reg may be a programmer view register (PV Reg) corresponding to the specific IP module IP_{S}. In practice, when the symbol “PV_Reg” of the aforementioned specific register represents the address of the programmer view register, the programmer can easily control the apparatus 100 by accessing the address PV_Reg+OFFSET. This is because that the apparatus 100 always follows the plurality of access rules {R} for the specific register PV_Reg under the control of the speed driver 120, where the symbol “OFFSET” can represent any offset selected from a series of offsets {OFFSET} defined in the innovative access scheme mentioned above.

According to some variations of the embodiment, the speed driver 120 can provide a pre-fetch service for the specific IP module IP_{S} to the simulation/emulation engine 110, and the IP proxy 130 interacts with the speed driver 120 to support the pre-fetch service for the specific IP module IP_{S}. For example, the apparatus 100 follows at least one portion of the plurality of access rules {R}, such as access rules R3 and R4, to perform the pre-fetch service equipped with synchronization and coherence under the control of the speed driver 120. In practice, the apparatus 100 performs multiple pre-fetch operations to perform the synchronization and coherence according to the access rules R3 and R4 under the control of the speed driver 120.

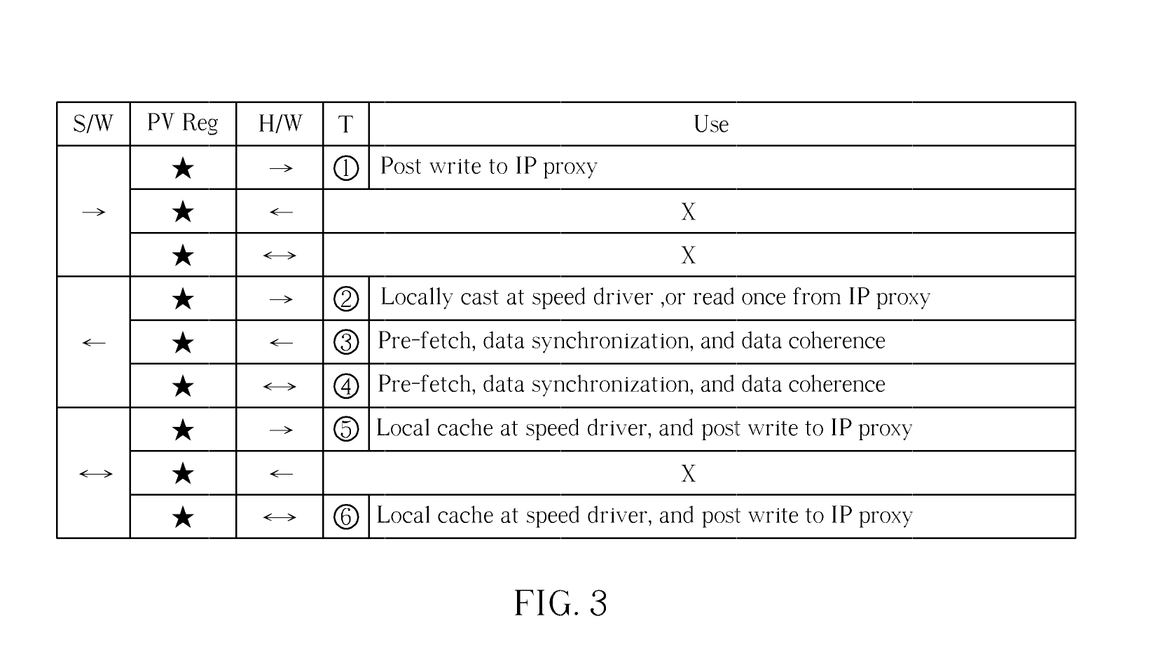

FIG. 3 is a diagram illustrating the access operation classification associated with the method 200 shown in FIG. 2 in an embodiment, especially the classification of a series of access operations defined in the innovative access manner mentioned above. The symbol “PV_Reg” still means the programmer view register mentioned above, and the symbols “S/W” and “H/W” represent the access direction of “PV Reg” accessed by the software in the apparatus 100 (in this embodiment, the software may be, for example, at least one of the simulation/emulation engine 110, the speed driver 120 and the IP proxy 130) and the access direction of “PV Reg” accessed by the hardware in the apparatus 100 (in this embodiment, the hardware may be, for example, the existing IP installation platform 140), respectively, and “T” represents the classification mark of the access operation.

As shown in FIG. 3, each star symbol listed in the column marked as “PV Reg” represents “PV Reg”, which can be used as the reference point of the access direction symbol. The arrows listed in two columns marked as “S/W” and “H/W” are access direction symbols, where these access direction symbols like “→”, “←”, “ [symbol] ” in FIG. 3 represent the access directions of “PV Reg” accessed by the software and the hardware. For example, the top arrow in the column marked as “S/W” points toward the star symbol, which means the software can perform a writing operation to “PV Reg”. For another example, the middle arrow in the column marked as “S/W” points away from the star symbol, which means the software can perform a reading operation to “PV Reg”. For yet another example, the bottom arrow in the column marked as “S/W” is bi-directional, which means the software can perform a reading operation and a writing operation to “PV Reg”.

Similarly, the top arrow in the column marked as “H/W” points away from the star symbol, which means the hardware can perform a reading operation to “PV Reg”. For another example, the second arrow in the column marked as “H/W” points toward the star symbol, which means the hardware can perform a writing operation to “PV Reg”; however, the access operation marked as “X” in the same row (i.e., the considered software access operation and hardware access operation whose access directions are illustrated in the first column and the third column, respectively) does not exist in the access operation classification. For another example, the fifth arrow in the column marked as “H/W” points toward the star symbol, which means the hardware can perform a writing operation to “PV Reg”. For yet another example, the sixth arrow in the column marked as “H/W” is bi-directional, which means the hardware can perform a writing operation and reading operation to “PV Reg”.

Besides, the symbols “1”, “2”, “3”, “4”, “5”, “6” (encircled) in the column marked as “T” represent six access operations in the aforementioned access operation classification (i.e., six sets of the software access operation and hardware access operation in the first row, the fourth row, the fifth row, the sixth row, the seventh row and the ninth row, where the access directions of the software access operation and hardware access operation are respectively illustrated in the first column and the third column), respectively, and correspond to the access rules R1, R2, R3, R4, R5, R6 in the plurality of access rules {R}, respectively.

The aforementioned access rules R1, R2, R3, R4, R5, R6 can be described according to the programmer view, where the writing/reading operations for “PV Reg” are described as writing/reading operations for the address PV_Reg of “PV Reg”. According to this embodiment, the access rule R1 includes:
at least one of the simulation/emulation engine 110, the speed driver 120, and the IP proxy 130 performs the writing operation to the specific register PV_Reg; and
the existing IP installation platform 140 performs a reading operation to the specific register PV_Reg;
where the access rule R1 is used to post write to IP proxy 130.

The access rule R2 includes:
at least one of the simulation/emulation engine 110, the speed driver 120, and the IP proxy 130 performs a reading operation to the specific register PV_Reg; and
the existing IP installation platform 140 performs a reading operation to the specific register PV_Reg;
where the access rule R2 is used to locally cast at speed driver 120 or read once from IP proxy 130.

The access rule R3 includes:
at least one of the simulation/emulation engine 110, speed driver 120, and IP proxy 130 performs a reading operation to the specific register PV_Reg, to make speed driver 120 provide the pre-fetch service equipped with synchronization and coherence to the simulation/emulation engine 110; and
the existing IP installation platform 140 performs a writing operation to the specific register PV_Reg, to support the pre-fetch service for the specific IP module IP_{S};
where the access rule R3 is used for pre-fetch, synchronization and coherence.

The access rule R4 includes:
at least one of the simulation/emulation engine 110, speed driver 120, and IP proxy 130 performs a reading operation to the specific register PV_Reg, to make speed driver 120 provide the pre-fetch service equipped with synchronization and coherence to the simulation/emulation engine 110; and
the existing IP installation platform 140 performs a writing operation to the specific register PV_Reg, to support the pre-fetch service for the specific IP module IP_{S};
where the access rule R4 is used for pre-fetch, synchronization and coherence.

The access rule R5 includes:
at least one of the simulation/emulation engine 110, speed driver 120, and IP proxy 130 performs a reading operation and a writing operation to the specific register PV_Reg, to make speed driver 120 provide the cache service to the simulation/emulation engine 110; and
the existing IP installation platform 140 performs a reading operation to the specific register PV_Reg, to support the cache service for the specific IP module IP_{S};
where the access rule R5 is used for local cache at speed driver 120 and post write to IP proxy 130.

The access rule R6 includes:
at least one of the simulation/emulation engine 110, speed driver 120, and IP proxy 130 performs a reading operation and a writing operation to the specific register PV_Reg, to make speed driver 120 provide the cache service to the simulation/emulation engine 110; and
the existing IP installation platform 140 performs a reading operation and a writing operation to the specific register PV_Reg, to support the cache service for the specific IP module IP_{S};
where the access rule R6 is used for local cache at speed driver 120 and post write to IP proxy 130.

Please note that, based on the plurality of access rules {R} such as the six access rules R1, R2, R3, R4, R5, R6 disclosed above, the apparatus 100 can operate with fastest speed by means of the control of the speed driver 120 without being limited by the low-speed feature of any single hardware element (e.g., any FPGA, if exists) on the existing IP installation platform 140. Therefore, the apparatus 100 and method 200 of the present invention can satisfy the requirement for some applications (e.g., chips with the target operating frequency reaching 500 MHz or 1 GHz) without generating any side effect.

Besides, because the apparatus 100 can speed up, especially speeding up by performing the cache operation and pre-fetch operation based on the plurality of access rules {R} such as the six access rules R1, R2, R3, R4, R5, R6 disclosed above, this allows the programmer to only focus on using apparatus 100 and taking advantage of the high speed feature of apparatus 100 without additional effort for adjusting/tuning the performance of apparatus 100. Thus, the speed driver 120 and IP proxy 130 can be called as the aforementioned “specific speed driver for applied engine” and “specific IP proxy for applied platform”, respectively.

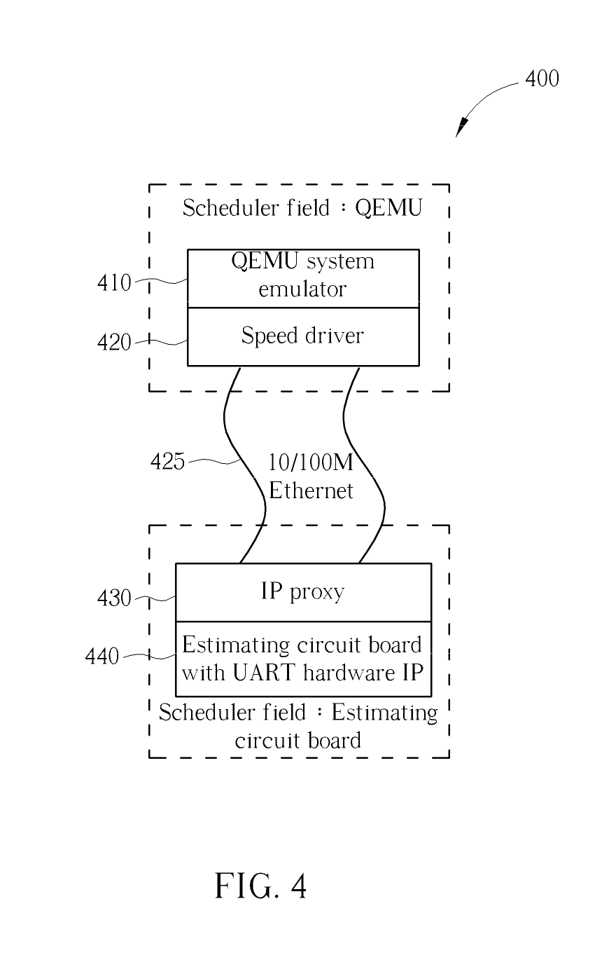

FIG. 4 is a diagram illustrating the implementation detail associated with the apparatus shown in FIG. 1 in an embodiment, where the apparatus of the present invention can be applied to the embodiment shown in FIG. 3. The QEMU system emulator 410, (specific) fast driver 420 (for QEMU), 10/100M Ethernet 425, (specific) IP proxy 430 (for applied estimation circuit board), estimation circuit 440 equipped with universal asynchronous receiver/transmitter (UART) hardware IP are examples for the simulation/emulation engine 110, speed driver 120, interconnection 125, IP proxy 130, and existing IP installation platform 140, respectively. Thus, the scheduler domains A, B of the embodiment are marked as “Scheduler domain: QEMU” and “Scheduler domain: estimation circuit board”, respectively.

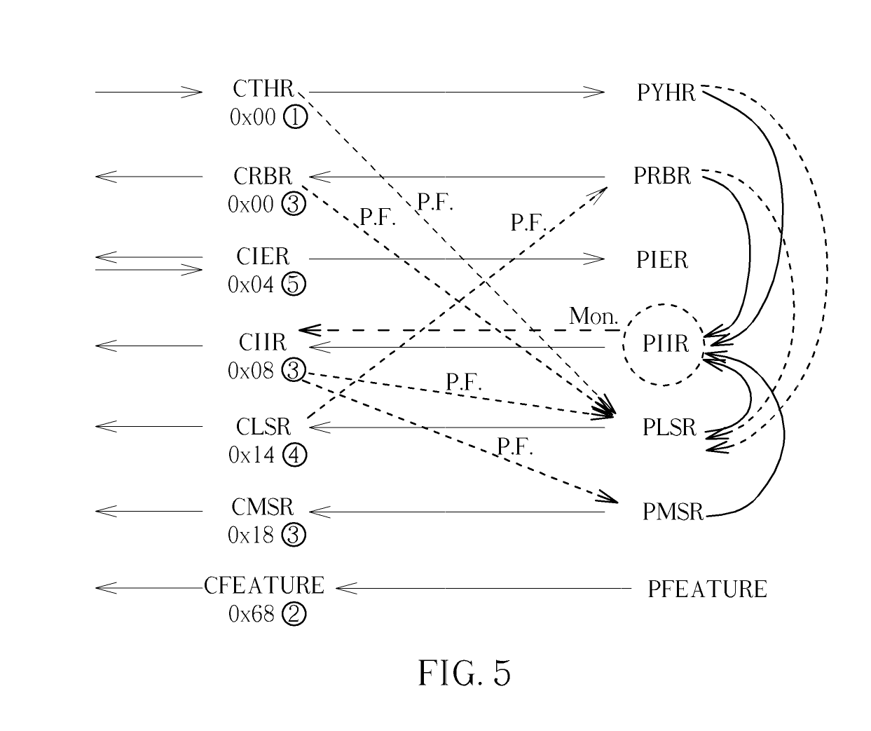

FIG. 5 is a diagram illustrating the access scheme associated with the method 200 shown in FIG. 2 in an embodiment, where the access scheme of the embodiment employs the access operation classification shown in FIG. 3. The access operation symbols CTHR, CRBR, CIER, CIIR, CLSR, CMSR, CFEATURE shown in FIG. 5 are all initialized with letter C, and represent access operations THR, RBR, IER, IIR, LSR, MSR, FEATURE cached in speed driver 120, respectively; and the access operation symbols PTHR, PRBR, PIER, PIIR, PLSR, PMSR, PFEATURE shown in FIG. 5 are all initialized with letter P, and represent access operations THR, RBR, IER, IIR, LSR, MSR, FEATURE on a real entity (e.g., existing IP installation platform 140), respectively; and the access purpose symbols “P.F.” and “Mon.” shown in FIG. 5 represent pre-fetch and monitor, respectively. As shown in FIG. 5, 0x00, 0x00, 0x04, 0x08, 0x4, 0x8, 0x14, 0x18, 0x68 under the access operation symbols CTHR, CRBR, CIER, CIIR, CLSR, CMSR, CFEATURE represent the corresponding offsets, and can be taken as examples of the offsets {OFFSET} mentioned above.

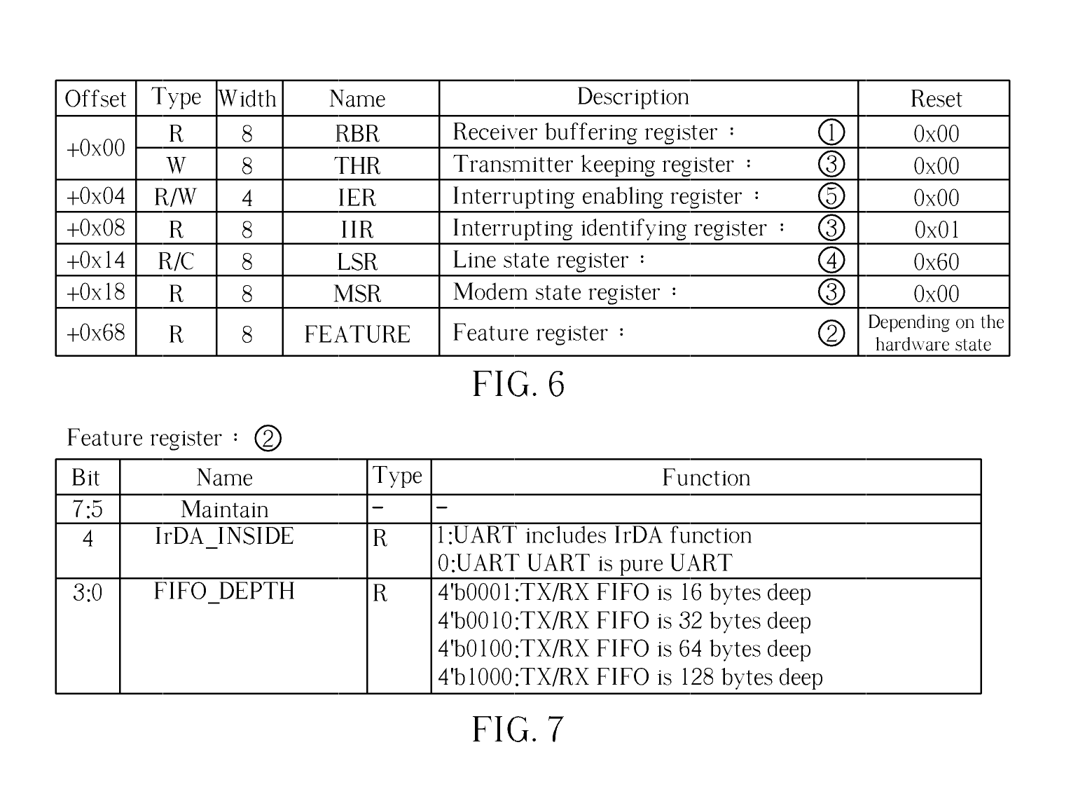

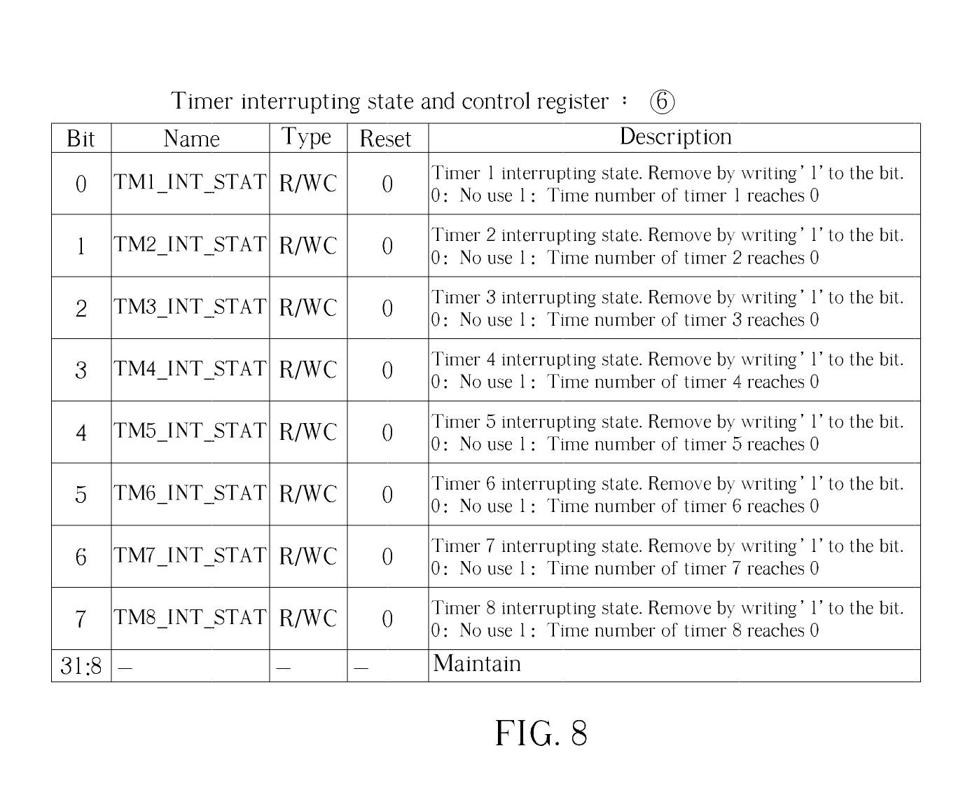

FIG. 6-FIG. 8 are diagrams illustrating the implementation detail associated with the access scheme shown in FIG. 5. As those skilled in the field can understand the context disclosed in FIG. 6-FIG. 8 based on the description of each embodiment and each variation mentioned above, further detail of FIG. 6-FIG. 8 is not described here for brevity.

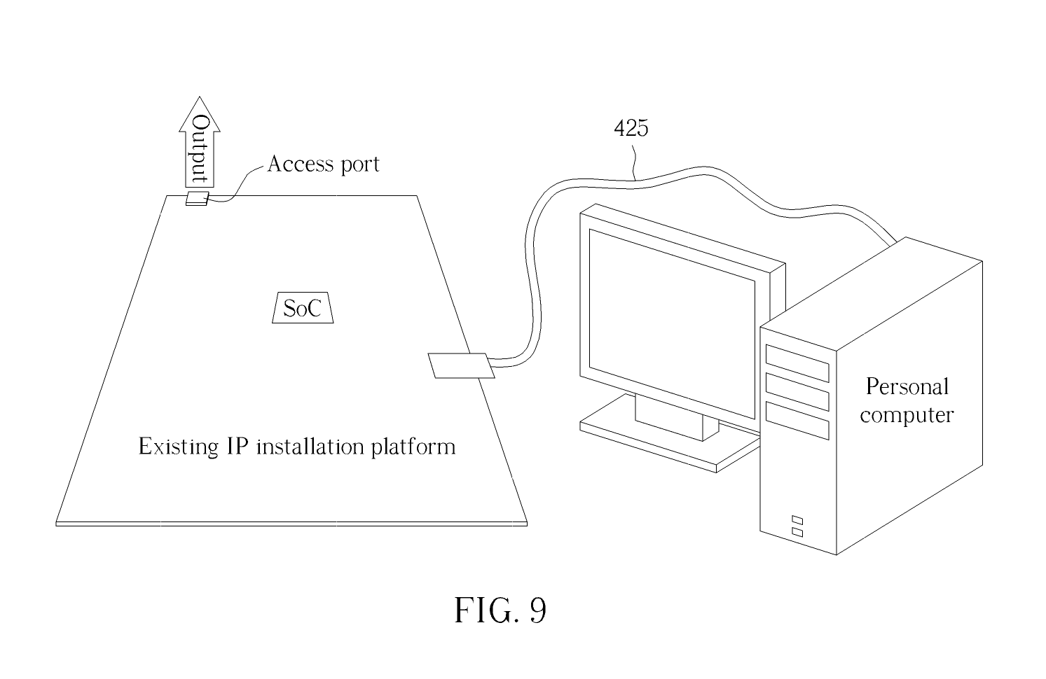

FIG. 9 is a diagram illustrating the implementation detail associated with the apparatus 400 shown in FIG. 4 in an embodiment, where the architecture shown in FIG. 9 can be applied to the embodiment shown in FIG. 5. In this embodiment, the aforementioned chip equipped with the existing IP modules {IP_{E}} may be a system on chip (SoC), so FIG. 9 illustrates the SoC installed on the existing IP installation platform. Besides, the software code of the aforementioned QEMU system emulator 410 can be executed on a personal computer shown in FIG. 9, and the monitor of the personal computer can display the interface of the emulator of the proposed architecture. Additionally, the apparatus 400 of this embodiment can simulate and/or emulate an electronic device equipped with an access port, especially emulating the electronic device to output the information to the user through the access port. Hence, the corresponding output information of the access port is illustrated on the top-left corner in FIG. 9.

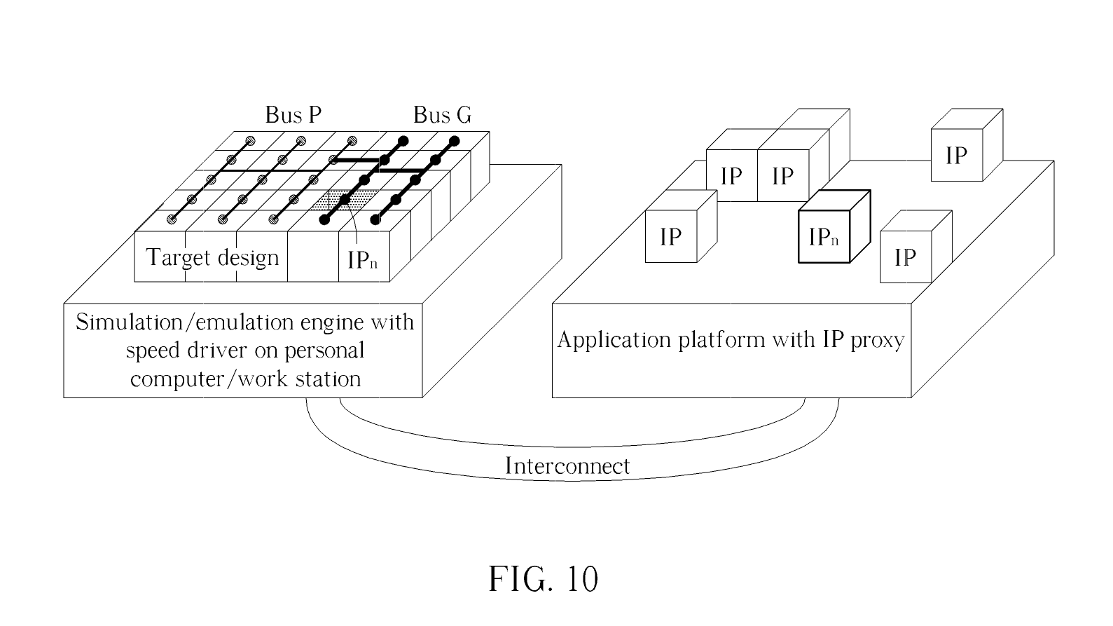

FIG. 10 is a diagram illustrating the mapping of the IP modules associated with the method 200 shown in FIG. 2 in an embodiment. As shown in the left half in FIG. 10, the aforementioned simulation/emulation engine 110 and speed driver 120 can implement the “simulation/emulation engine equipped with speed driver on the personal computer/work station”, where each block interconnected by buses P, G on the simulation/emulation engine can be examples for the first portion of the plurality of IP modules {IP} (e.g., the first subset {IP_{A}} in IP modules {IP}) mentioned above. Please note that, there is a hole surrounded by these blocks, which represents the IP module obtained on the bus G through mapping.

As shown in right half in FIG. 10, the aforementioned IP proxy 130 and the existing IP installation platform 140 can implement the “application platform equipped with IP proxy”, where IP module IPₙ can be an example for the specific IP module IP_{S} mentioned above, and the IP module on the application platform can be an example for the existing IP modules {IP_{E}} mentioned above. To emphasize the IP module IPₙ, all other modules are simply labeled as IP without suffix. The apparatus 100 can provide the mapping relation between the IP module IPₙ and the hole mentioned above, thereby making apparatus 100 equipped with the second portion of the plurality of IP modules {IP} (e.g., the second subset {IP_{B}} in IP modules {IP}). Since the apparatus 100 always follows the plurality of access rules {R} for the specific register PV_Reg under the control of speed driver 120, and apparatus 100 can provide the mapping relation between the IP module IPₙ and the hole mentioned above, the programmer can easily control the apparatus 100 by an access address PV_Reg+OFFSET without additional effort for controlling the bottom layer of the apparatus 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus of system level simulation and emulation, comprising:
a simulation/emulation engine, arranged for performing at least one of simulation and emulation to make the apparatus equipped with a first portion of a plurality of intellectual property (IP) modules, wherein each of the IP modules provides a function to the apparatus;
an existing IP installation platform, arranged for installing a chip equipped with existing IP modules to make the apparatus equipped with a second portion of the plurality of IP modules, wherein the second portion of the plurality of IP modules includes a specific IP module of the existing IP modules, and the specific IP module provides a specific function to the apparatus;
a speed driver, arranged for bridging the simulation/emulation engine to an interconnection between the simulation/emulation engine and the existing IP installation platform, and providing the simulation/emulation engine with a cache service corresponding to the specific IP module; and
an IP proxy, arranged for bridging the existing IP installation platform to the interconnection, and interacting with the speed driver to support the cache service corresponding to the specific IP module.

2. The apparatus of claim 1, wherein the speed driver provides the simulation/emulation engine with a pre-fetch service corresponding to the specific IP module; and the IP proxy interacts with the speed driver to support the pre-fetch service corresponding to the specific IP module.

3. The apparatus of claim 2, wherein the existing IP installation platform includes a specific register; and under control of the speed driver, the apparatus follows at least a portion of a plurality of access rules corresponding to the specific register, to proceed with the pre-fetch service with synchronization and coherence; and the apparatus proceeds with synchronization and coherence by proceeding with multiple pre-fetch operations according to the portion of the plurality of access rules.

4. The apparatus of claim 3, wherein an access rule of the plurality of access rules comprises:
at least one of the simulation/emulation engine, the speed driver, and the IP proxy performs a read operation upon the specific register, to make the speed driver provide the pre-fetch service to the simulation/emulation engine; and
the existing IP installation platform performs a write operation upon the specific register, to support the pre-fetch service corresponding to the specific IP module.

5. The apparatus of claim 4, wherein another access rule of the plurality of access rules comprises:
at least one of the simulation/emulation engine, the speed driver, and the IP proxy performs a read operation upon the specific register, to make the speed driver provide the pre-fetch service to the simulation/emulation engine; and
the existing IP installation platform performs a write operation and a read operation upon the specific register, to support the pre-fetch service corresponding to the specific IP module.

6. The apparatus of claim 3, wherein an access rule of the plurality of access rules comprises:
at least one of the simulation/emulation engine, the speed driver, and the IP proxy performs a read operation upon the specific register, to make the speed driver provide the pre-fetch service to the simulation/emulation engine; and
the existing IP installation platform performs a write operation and a read operation upon the specific register, to support the pre-fetch service corresponding to the specific IP module.

7. The apparatus of claim 1, wherein the existing IP installation platform comprises a specific register; and under control of the speed driver, the apparatus follows at least a portion of a plurality of access rules corresponding to the specific register to proceed with the cache service.

8. The apparatus of claim 7, wherein an access rule of the plurality of access rules comprises:
at least one of the simulation/emulation engine, the speed driver, and the IP proxy performs a read operation and a write operation upon the specific register, to make the speed driver provide the cache service to the simulation/emulation engine; and
the existing IP installation platform performs a read operation upon the specific register, to support the cache service corresponding to the specific IP module.

9. The apparatus of claim 8, wherein another access rule of the plurality of access rules comprises:
at least one of the simulation/emulation engine, the speed driver, and the IP proxy performs a read operation and a write operation upon the specific register, to make the speed driver provide the cache service to the simulation/emulation engine; and
the existing IP installation platform performs a read operation and a write operation upon the specific register, to support the cache service corresponding to the specific IP module.

10. The apparatus of claim 7, wherein an access rule of the plurality of access rules comprises:
at least one of the simulation/emulation engine, the speed driver, and the IP proxy performs a read operation and a write operation upon the specific register, to make the speed driver provide the cache service to the simulation/emulation engine; and
the existing IP installation platform performs a read operation and a write operation upon the specific register, to support the cache service corresponding to the specific IP module.

11. The apparatus of claim 1, wherein the existing IP installation platform comprises a specific register; and under control of the speed driver, the apparatus follows a plurality of access rules corresponding to the specific register; and a first access rule of the plurality of access rules comprises:
at least one of the simulation/emulation engine, the speed driver, and the IP proxy performs a write operation upon the specific register; and
the existing IP installation platform performs a read operation upon the specific register.

12. The apparatus of claim 11, wherein a second access rule of the plurality of access rules comprises:
at least one of the simulation/emulation engine, the speed driver, and the IP proxy performs a read operation upon the specific register; and
the existing IP installation platform performs a read operation upon the specific register.

13. The apparatus of claim 12, wherein a third access rule of the plurality of access rules comprises:
at least one of the simulation/emulation engine, the speed driver, and the IP proxy performs a read operation upon the specific register, to make the speed driver provide the simulation/emulation engine with a pre-fetch service with synchronization and coherence; and
the existing IP installation platform performs a write operation upon the specific register, to support the pre-fetch service corresponding to the specific IP module.

14. The apparatus of claim 13, wherein a fourth access rule of the plurality of access rules comprises:
at least one of the simulation/emulation engine, the speed driver, and the IP proxy performs a read operation upon the specific register, to make the speed driver provide the pre-fetch service to the simulation/emulation engine; and
the existing IP installation platform performs a write operation and a read operation upon the specific register, to support the pre-fetch service corresponding to the specific IP module.

15. The apparatus of claim 14, wherein a fifth access rule of the plurality of access rules comprises:
at least one of the simulation/emulation engine, the speed driver, and the IP proxy performs a read operation and a write operation upon the specific register, to make the speed driver provide the cache service to the simulation/emulation engine; and
the existing IP installation platform performs a read operation upon the specific register, to support the cache service corresponding to the specific IP module.

16. The apparatus of claim 15, wherein a sixth access rule of the plurality of access rules comprises:
at least one of the simulation/emulation engine, the speed driver, and the IP proxy performs a read operation and a write operation upon the specific register, to make the speed driver provide the cache service to the simulation/emulation engine; and
the existing IP installation platform performs a read operation and a write operation upon the specific register, to support the cache service corresponding to the specific IP module.

17. A method of system level simulation and emulation, comprising:
utilizing a simulation/emulation engine to perform at least one of simulation and emulation to make an apparatus equipped with a first portion of a plurality of intellectual property (IP) modules, wherein each of the IP modules provides a function to the apparatus;
utilizing an existing IP installation platform to install a chip equipped with existing IP modules to make the apparatus equipped with a second portion of the plurality of IP modules, wherein the second portion of the plurality of IP modules includes a specific IP module of the existing IP modules, and the specific IP module provides a specific function to the apparatus;
utilizing a speed driver to bridge the simulation/emulation engine to an interconnection between the simulation/emulation engine and the existing IP installation platform, and to provide the simulation/emulation engine with a cache service corresponding to the specific IP module; and
utilizing an IP proxy to bridge the existing IP installation platform to the interconnection, and to interact with the speed driver to support the cache service corresponding to the specific IP module.

18. The method of claim 17, further comprising:
utilizing the speed driver to provide the simulation/emulation engine with a pre-fetch service corresponding to the specific IP module; and
utilizing the IP proxy to interact with the speed driver to support the pre-fetch service corresponding to the specific IP module.

19. The method of claim 18, wherein the method is applied to the apparatus comprising the simulation/emulation engine, the existing IP installation platform, the speed driver, and the IP proxy; the existing IP installation platform includes a specific register; and the method further comprises:
utilizing the speed driver to control the apparatus to follow a plurality of access rules to proceed with the pre-fetch service with synchronization and coherence.

20. The method of claim 17, wherein the method is applied to the apparatus comprising the simulation/emulation engine, the existing IP installation platform, the speed driver, and the IP proxy; the existing IP installation platform includes a specific register; and the method further comprises:
utilizing the speed driver to control the apparatus to follow six access rules corresponding to the specific register, wherein at least a portion of the six access rules is utilized for controlling at least one of the simulation/emulation engine, the speed driver, and the IP proxy to perform at least one of a read operation and a write operation, and at least a portion of the six access rules is utilized for controlling the existing IP installation platform to perform at least one of a read operation and a write operation.
